(19) United States
(12) Patent Application Publication
(10) Pub. No.: US 2015/0212912 A1
(43) Pub. Date: Jul. 30, 2015

(54) PERFORMANCE MITIGATION OF LOGICAL UNIT NUMBERS (LUNS) USING SMALL COMPUTER SYSTEM INTERFACE (SCSI) INBAND MANAGEMENT

(71) Applicant: International Business Machines Corporation, Armonk, NY (US)

(72) Inventors: Kiran K. Anumalasetty, Bangalore (IN); Venkata N.S. Anumula, Hyderabad (IN); Gary S. Domrow, Austin, TX (US); Nicholas S. Ham, Austin, TX (US)

(21) Appl. No.: 14/307,523

(22) Filed: Jun. 18, 2014

Related U.S. Application Data
(63) Continuation of application No. 14/165,852, filed on Jan. 28, 2014.

(51) Int. Cl. G06F 11/20

(52) U.S. Cl. CPC G06F 11/2089

(57) ABSTRACT

A computer system for providing small computer system interface inband of storage area network computing environment is provided. The computer system comprises selecting signals of a primary path group that corresponds to a primary logical unit number of a primary device of a storage area network computing environment. The computer system further comprises detecting signal failures of the primary path group that corresponds to the primary logical unit number. The computer system further comprises initiating failover of the failed signals of the primary logical unit number from the primary device to a secondary logical unit number of a secondary device or a tertiary logical unit number of a tertiary device. The computer system further comprises registering, one or more applications of the storage area network computing environment for failover event notifications based on signal failures of the primary logical unit number of the primary device.

### CROSS REFERENCE

The present application is a continuation of and claims priority under 35 U.S.C. §120 of U.S. patent application Ser. No. 14/165,852, filed on Jan. 28, 2014, which is incorporated by reference in its entirety.

### BACKGROUND

The present invention relates generally to the data processing of computing systems, and more particularly to the fail-over management of the failure of LUNs using small computer system interface (SCSI) inband management of one or more computing systems within a storage area network (SAN) of a Peer to Peer Remote Copy (PPRC) computing environment.

Peer to Peer Remote Copy or PPRC is a protocol to replicate a storage volume to another control unit in a remote site of a computing environment. For example, I/O operations of the computing environment are considered complete when an update to both a primary volume and a secondary volume of the computer environment is complete. Further, PPRC can also provide replication mechanisms for disaster recovery and business continuity within the computing environment. The computing environment can include a pair of logical unit numbers (LUNs) for addressing the disaster recovery and business continuity within the computing environment. For example, a LUN, is a number used to identify a logical unit of small computer system interface (SCSI) of the computing environment. The SCSI is a set of standards for physically connecting and transferring data between computers and peripheral devices of the computing environment. The PPRC typically allows one LUN to be located in Site A (primary) and another LUN to be located in Site B (secondary), wherein the primary and the secondary are designated as a PPRC pair.

### SUMMARY

An embodiment of the present invention comprises a computer-implemented method for providing small computer system interface inband protocol for managing replication services of a storage area network computing environment by transmitting small computer system interface commands to computing systems of the storage area network computing environment.

The computer-implemented method comprises selecting, by one or more processors signals of a primary path group that corresponds to a primary logical unit number of a primary device of a storage area network computing environment. The computer-implemented method further comprises detecting, by the one or more processors signal failures of the primary path group that corresponds to the primary logical unit number. The computer-implemented method further comprises initiating, by the one or more processors failover of the failed signals of the primary logical unit number from the primary device to a secondary logical unit number of a secondary device, or a tertiary logical unit number of a tertiary device. The computer-implemented method further comprises registering, by the one or more processors, one or more applications of the storage area network computing environment for failover event notifications, wherein the failover event notifications are based on signal failures of the primary logical unit number of the primary device.

Another embodiment of the present invention comprises a computer system for providing small computer system interface inband protocol for managing replication services of a storage area network computing environment by transmitting small computer system interface commands to computing systems of the storage area network computing environment. The computer system comprises one or more processors, one or more computer-readable memories, one or more computer-readable tangible storage devices, and program instructions which are stored on at least one of the one or more storage devices for execution by at least one of the one or more processors via at least one of the one or more memories. The computer system comprises program instructions to select signals of a primary path group that corresponds to a primary logical unit number of a primary device of a storage area network computing environment. The computer system further comprises program instructions to detect signal failures of the primary path group that corresponds to the primary logical unit number. The computer system further comprises program instructions to initiate failover of the failed signals of the primary logical unit number from the primary device to a secondary logical unit number of a secondary device or a tertiary logical unit number of a tertiary device.

The computer system further comprises program instructions to register one or more applications of the storage area network computing environment for failover event notifications, wherein the failover event notifications are based on signal failures of the primary logical unit number of the primary device.

Yet another embodiment of the present invention comprises a computer program product for providing small computer system interface inband protocol for managing replication services of a storage area network computing environment by transmitting small computer system interface commands to computing systems of the storage area network computing environment. The computer program product comprises one or more computer-readable tangible storage devices and program instructions stored on at least one of the one or more storage devices.

The computer program product further comprise program instructions to select signals of a primary path group that corresponds to a primary logical unit number of a primary device of a storage area network computing environment. The computer program product further comprises program instructions to detect signal failures of the primary path group that corresponds to the primary logical unit number. The computer program product further comprises program instructions to initiate failover of the failed signals of the primary logical unit number from the primary device to a secondary logical unit number of a secondary device or a tertiary logical unit number of a tertiary device. The computer program product further comprises program instructions to register one or more applications of the storage area network computing environment for failover event notifications, wherein the failover event notifications are based on signal failures of the primary logical unit number of the primary device.

### BRIEF DESCRIPTION OF THE SEVERAL VIEWS OF THE DRAWINGS

Novel characteristics of the invention are set forth in the appended claims. The invention will be best understood by reference to the following detailed description of the invention when read in conjunction with the accompanying Figures, wherein like reference numerals indicate like components, and:

FIG. 1 is a storage area network (SAN) computing environment for fail-over management of the failure of LUNs of failure of logical unit numbers (LUNs) in copy relationships of at least one storage computing system of the SAN computing environment, in accordance with embodiments of the present invention.

FIGS. 2A-2B are flow diagrams depicting steps performed by a host path control module for fail-over management of the failure of LUNs from a primary server computing system to a secondary server computing system or a tertiary server computing system within a storage area network computing environment.

FIG. 3 is a flow diagram depicting steps performed by a host path control module for providing SCSI inband protocol for managing replication services of a SAN computing environment, in accordance with embodiments of the present invention.

FIG. 4 illustrates a block diagram of components of a computer system, in accordance with embodiments of the present invention.

### DETAILED DESCRIPTION

Embodiments of the present invention comprise failover management of logical unit numbers (LUNs) in copy relationships of storage computing systems, within a storage area network (SAN) computing environment, using small computer system interface (SCSI) inband management feature of the SAN computing environment.

According to at least one embodiment, the SCSI inband management feature provides a host path control module that selects signals of a primary path group that corresponds to primary LUNs of a primary device of the SAN computing environment. For instance, the host path control module detects signal failures of the primary path group that corresponds to the primary LUNs, and initiates failover of the failed signals of the primary LUNs from the primary device to secondary LUNs of a secondary device, or tertiary LUNs of a tertiary device. The host path control module further registers one or more applications of the SAN computing environment for failover event notifications, wherein the failover event notifications are based on signal failures of the primary LUNs of the primary device.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module” or “system”. Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including, but not limited to, wireless, wireline, optical fiber cable, RF, etc., or any suitable combination of the foregoing. Computer program code for carrying out operations for aspects of the present invention may be written in any combination of one or more programming languages, including an object-oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture, including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions which execute on the computer or other programmable apparatus provide processes for implementing the functions/acts specified in the flowchart and/or block diagram block or blocks.

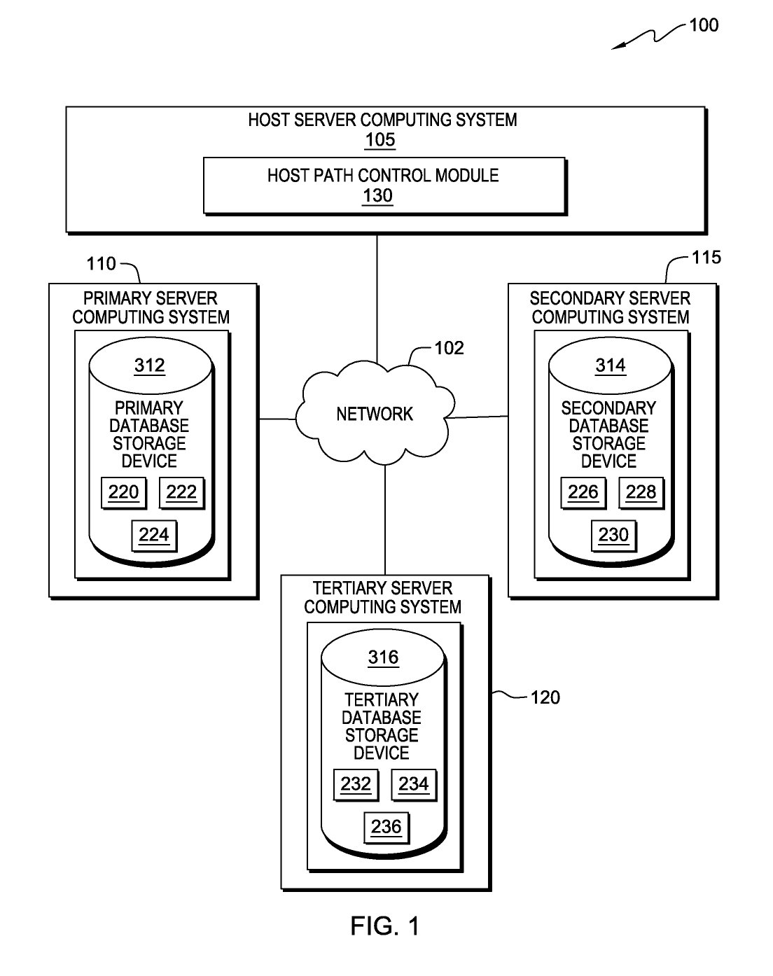

The present invention will now be described in detail with reference to the accompanying Figures. Referring now to FIG. 1, storage area network (SAN) computing environment 100 for performing management of failure of logical unit numbers (LUNs) in copy relationships of at least one storage computing system of SAN computing environment 100 using small computer system interface (SCSI) inband management feature of SAN computing environment 100, is shown in accordance with the present invention. SAN computing environment 100 includes host server computing system 105, primary server computing system 110, secondary server computing system 115, and tertiary server computing system 120, all interconnected over network 102.

Network 102 can be any kind of network that provides communication links between various devices and computers connected together within SAN computing environment 100. Network 102 can also include connections, such as wired communication links, wireless communication links, or fiber optic cables. Network 102 can also be implemented as a number of different types of networks, including, for example, a local area network (LAN), a wide area network (WAN) or a packet switched telephone network (PSTN), or some other networked system. For example, SAN computing environment 100 can utilize the Internet with network 102 representing a worldwide collection of networks to perform management of failure of logical unit numbers (LUNs) in copy relationships of storage computing system of SAN computing environment 100. For example, the term “Internet” as used according to embodiments of the present invention refers to a network or networks that uses certain protocols, such as the TCP/IP protocol, and possibly other protocols, such as the hypertext transfer protocol (HTTP) for hypertext markup language (HTML) documents that make up the World Wide Web (the Web).

Host server computing system 105 stores data of SAN computing environment 100 in primary server computing system 110. For instance, data written to primary server computing system 110 is copied to secondary server computing system 115 or tertiary server computing system 120. The copy process of the write operation creates a copy of the data from primary server computing system 110 to secondary server computing system 115 or tertiary server computing system 120. For instance, the copy process of the write operation is a peer to peer remote copy (PPRC) mechanism. Typically, the PPRC mechanism is a synchronous copy mechanism that creates a copy of data at secondary server computing system 115 or tertiary server computing system 120.

According to aspects of the present invention, this copy at secondary server computing system 115 or tertiary server computing system 120 is kept current with the data located at primary server computing system 110. In other words, a copy of the data located at secondary server computing system 115 or tertiary server computing system 120 is kept in sync with the data at the primary storage system as observed by the user of the data. Further, volume pairs are designated in which a volume of data in primary server computing system 110 is paired with a volume in secondary server computing system 115 or tertiary server computing system 120. For example, according to aspects of the present invention, within SAN computing environment 100, a write operation made by primary server computing system 110 is considered complete only after the date written to primary server computing system 110 is also written to secondary server computing system 115 or tertiary server computing system 120.

Specifically, during operation of SAN computing environment 100, primary server computing system 110 transmits data over network 102 to secondary server computing system 115 or tertiary server computing system 120, each time data is written to primary server computing system 110 by host server computing system 105. Secondary server computing system 115 or tertiary server computing system 120 then copies the data to a secondary storage volume of secondary server computing system 115 or a tertiary storage of tertiary server computing system 120 that corresponds to a primary storage volume of primary server computing system 110.

Host server computing system 105 is a server computing system, such as a management server, a web server, or any other electronic device or computing system. For example, the server computing system can also represent a “cloud” of computers interconnected by one or more networks, wherein the server computing system can be a host server computing system that utilizes clustered computers when accessed through SAN computing environment 100. For example, according to at least one embodiment, a cloud computing system can be a common implementation of failover management of logical unit numbers (LUN) in copy relationships of primary server computing system 110 and secondary server computing system 115, using small computer system interface (SCSI) inband management feature, wherein the SCSI inband management feature provides storage subsystem to host server computing system 105 that initiates the failover on its own when failure of primary LUNs of primary server computing system 110 are detected within SAN computing environment 100, in accordance with the present invention.

Primary server computing system 110 is a server computing system, such as a management server, a web server, or any other electronic device or computing system. For example, primary server computing system 110 can also represent a “cloud” of computers interconnected by one or more networks, wherein primary server computing system 110 can utilize clustered computers when accessed through SAN computing environment 100. Primary database storage device 312 can be any type of storage device, storage server, storage area network, redundant array of independent discs (RAID), cloud storage device, or any type of data storage. For example, primary database storage device 312 is a relational database management system (RDBMS). A RDBMS is a database that stores information from database logging activities of primary server computing system 110. Information stored in primary database storage device 312 can be structured or unstructured information of database logs, including a history of actions executed by primary server computing system 110 to guarantee ACID properties over crashes or operational hardware failures of primary database storage device 312, in accordance with aspects of the present invention.

Secondary server computing system 115 is a server computing system, such as a management server, a web server, or any other electronic device or computing system. For example, the server computing system can also represent a “cloud” of computers interconnected by one or more networks, wherein the server computing system can be a host server computing system that utilizes clustered computers when accessed through SAN computing environment 100. Secondary server computing system 115 includes secondary database storage device 314. Secondary database storage device 314 can be any type of storage device, storage server, storage area network, redundant array of independent discs (RAID), cloud storage device, or any type of data storage. For example, secondary database storage device 314 is a relational database management system (RDBMS). A RDBMS is a database that stores information from database logging activities of SAN computing environment 100. Information stored in secondary database storage device 314 can be structured or unstructured information of database logs, including a history of actions executed by secondary storage server computing system 115 to guarantee ACID properties over crashes or operational hardware failures of secondary database storage device 314, in accordance with aspects of the present invention.

Tertiary server computing system 120 is a server computing system, such as a management server, a web server, or any other electronic device or computing system. For example, the server computing system can also represent a “cloud” of computers interconnected by one or more networks, wherein the server computing system can be a host server computing system that utilizes clustered computers when accessed through SAN computing environment 100. Tertiary server computing system 120 includes tertiary database storage device 316. Tertiary database storage device 316 can be any type of storage device, storage server, storage area network, redundant array of independent discs (RAID), cloud storage device, or any type of data storage. For example, tertiary database storage device 316 is a relational database management system (RDBMS). A RDBMS is a database that stores information from database logging activities of SAN computing environment 100. Information stored in tertiary database storage device 316 can be structured or unstructured information of database logs, including a history of actions executed by tertiary server computing system 120 to guarantee ACID properties over crashes or operational hardware failures of tertiary database storage device 316, in accordance with aspects of the present invention.

According to aspects of the present invention, primary database storage device 312 includes a set of storage volumes 220, 222, and 224. Secondary database storage device 314 includes a set of storage volumes 226, 228, and 230. Further, tertiary database storage device 316 includes a set of storage volumes 232, 234, and 236. Secondary storage volumes 226, 228, and 230 and tertiary storage volumes 232, 234, and 236 correspond to primary storage volumes 220, 222, and 224. The correspondence between the volumes in primary database storage device 312, secondary database storage device 314 and tertiary database storage device 316 is set up in PPRC pairs, such that a storage volume in primary database storage device 312 has a corresponding storage volume in secondary database storage device 314 and tertiary database storage device 316. For instance, according to aspects of the present invention, primary volume 220 is paired with secondary volume 226 and tertiary volume 232, primary volume 222 is paired with secondary volume 228 and tertiary volume 234, and primary volume 224 is paired with secondary volume 230 and tertiary volume 236. These pairs are referred to as established PPRC pairs of SAN computing environment 100, wherein failover management of logical unit numbers (LUN) in copy relationships of primary server computing system 110 and secondary server computing system 115 and tertiary server computing system 120, using small computer system interface (SCSI) inband management feature can be mitigated, and wherein the SCSI inband management feature provides storage subsystem to host server computing system 105, and wherein host server computing system 105 independently initiates failover when failure of primary LUNs of primary server computing system 110 are detected within SAN computing environment 100, as described below, in accordance with the present invention.

According to aspects of the present invention, host server computing system 105 has visibility to primary LUNs of primary server computing system 110. Similarly, host server computing system 105 has visibility to secondary LUNs of secondary server computing system 110 and tertiary LUNs of tertiary server computing system 120. For example, primary LUNs, secondary LUNs and tertiary LUNs are in copy relation with each other, wherein the copy relation of the primary LUNs, the secondary LUNs and the tertiary LUNs is based on replication of data between the primary LUNs, the secondary LUNs and the tertiary LUNs of SAN computing environment 100. For example, in the event of an outage of SAN computing environment 100, if a copy of data of either of the primary LUNs, the secondary LUNs or the tertiary LUNs is not available, host server computing system 105 is adaptive to continue system operations of SAN computing environment 100 by accessing data of either of the primary LUNs, the secondary LUNs or the tertiary LUNs. Typically in a PPRC environment, either of the primary LUNs, the secondary LUNs or the tertiary LUNs can be accessed by host server computing system 105 through multiple paths or paths groups. For example, primary LUNs on primary server computing system 110 can have up to four paths which can be accessed by host server computing system 105. Similarly, secondary LUNs on secondary server computing system 115 can also have multiple paths which can be accessed by host server computing system 105, and similarly, tertiary LUNs on tertiary server computing system 120 can also have multiple paths which can be accessed by host server computing system 105, in accordance with the present invention.

According to aspects of the present invention, primary LUNs, secondary LUNs or tertiary LUNs are detected by a host server computing system as a single replication disk of SAN computing environment. For example, all paths to primary LUNs are logically grouped into a single path group, and similarly, all paths to secondary LUNs and tertiary LUNs are grouped into another single path group. In this manner, in at least one embodiment, host server computing system 105 has access to the same disk of primary server computing system 110, secondary server computing system 115 and tertiary server computing system 120 through multiple I/O paths. In such case, the multiple paths to the disk of primary server computing system 110, secondary server computing system 115 and tertiary server computing system 120 are managed through host path control module 130 of host server computing system 105. According to aspects of the present invention, consider for example, storage of a primary disk of SAN computing environment 100 is stored in primary server computing system 110, and also consider, storage of a secondary disk is stored on secondary server computing system 115 or a tertiary disk is stored on tertiary server computing system 120. In this scenario, it is possible to have host server computing system 105 access data of either or both of primary disk, secondary disk or tertiary disk within SAN computing environment 100.

Also, consider that primary server computing system 110 powers down due to either a disaster or outage, in this case according to at least one embodiment, the present invention is adapted to detect system failure of primary server computing system 110 due to the outage. Embodiments of the present invention are also adaptive to initiate the failover from a primary copy of the primary disk to a secondary copy of secondary disk, or a tertiary copy of a tertiary disk, in accordance with embodiments of the present invention. In the depicted environment, according to at least one embodiment, host path control module 130 is adapted to detect storage subsystem failure of SAN computing environment 100 in the event of disaster or outage of SAN computing environment 100. According to one embodiment of present invention, due to the outage, host path control module 130 initiates or triggers a failover of data of SAN computing environment from either of primary server computing system 115, secondary server computing system 115 or tertiary server computing system 120 without dependence on external agent or application to initiate the failover procedure within SAN computing environment 100. Accordingly, the present invention provides improved recovery of the disaster of SAN computing environment 100, since host path control module 130 is managing the failover using inband SCSI commands. For example, with inband management of SAN computing environment 100, failover request by host path control module 130 is transmitted as a SCSI command over network 102.

According to at least one embodiment, during a planned outage or maintenance activity at primary server computing system 110, an administrator of SAN computing environment 100 can initiate a failover from upper layer systems applications of SAN computing environment 100. In this manner, host path control module 130 receives the failover request from the upper layer systems application. Further, according to aspects of the present invention, a primary pathgroup of primary server computing system 110 is suspended.

Thereafter, host path control module 130 transmits the SCSI failover command to secondary server computing system 115 or tertiary server computing system 120. In the event of a system outage or disaster at primary server computing system 110, host path control module 130 performs failover from primary LUNs at primary server computing system 110 to secondary LUNs of secondary server computing system 115 or tertiary LUNs of tertiary server computing system 120, wherein host path control module 130 independently transmits failover SCSI inband commands over SAN computing environment 100. Moreover, in the event of a planned maintenance at primary server computing system 110, a disaster recovery solution operating on primary server computing system 1105 can register with host path control module 130 and initiate failover from primary LUNs at primary server computing system 110 to secondary LUNs of secondary server computing system 115 or tertiary LUNs of tertiary server computing system 120, without depending on any out of band SAN management products of SAN computing environment.

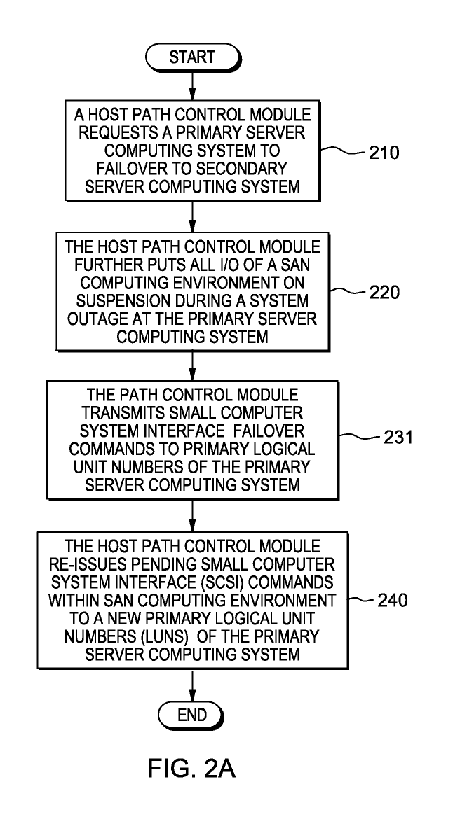

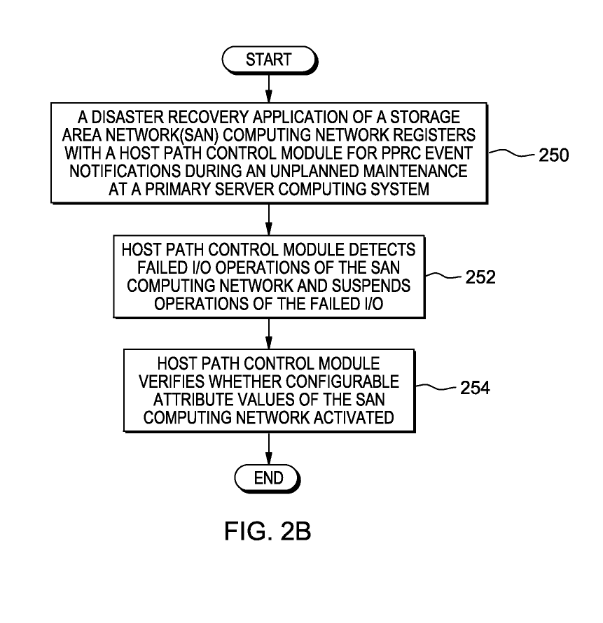

FIG. 2A is a flow diagram depicting steps performed by host path control module 130 to perform failover from primary server computing system 110 to secondary server computing system 115 or tertiary server computing system 120 within SAN computing environment 100 in the event of a planned maintenance at primary server computing system 110, in accordance with at least one embodiment of the present invention. According to at least one embodiment of the present invention, in the event of a system outage of primary server computing system 110, host path control module requests primary server computing system to failover to secondary server computing system or tertiary server computing system 120 (Step 210). Further, according to at least one embodiment, during failover, host path control module further puts all I/O of SAN computing environment 100 on suspension (Step 220). Path control module transmits SCSI failover commands to primary LUNs of primary server computing system (Step 231). Moreover, after successful failover from primary server computing system to secondary server computing system, host path control module 130 reissues pending SCSI commands within SAN computing environment to new primary LUNs of primary server computing system (Step 240).

FIG. 2B is a flow diagram depicting steps performed by host path control module 130 to perform failover from primary server computing system 110 to secondary server computing system 115 or tertiary server computing system 120 within SAN computing environment 100 in the event of an unplanned maintenance at primary server computing system 110. According to aspects of the present invention, a disaster recovery application of SAN computing network 100 registers with host path control module for PPRC event notifications during an unplanned maintenance at primary server computing system 110, wherein I/O operations at primary server computing system 110 failed after a system outage at primary server computing system 110 (Step 250). Host path control module 130 detects the failed I/O operations of SAN computing environment 100 and suspends operations of the failed I/O (Step 252). Host path control module 130 verifies whether configurable attribute values of SAN computing environment are activated (Step 254). If the configurable attribute values are activated, then path control module notifies disaster recover software of SAN computing environment about the site failure. The disaster recovery application then requests path control module to failover to secondary server computing system 115 or tertiary server computing system 120. However, if path control module does not verify whether configurable attribute values of SAN computing environment are activated, then path control module transmits SCSI failover command to secondary LUNs of secondary server computing system or tertiary LUNs of tertiary server computing system 120. Moreover, after successful failover, path control module reissues pending commands to new primary LUNs.

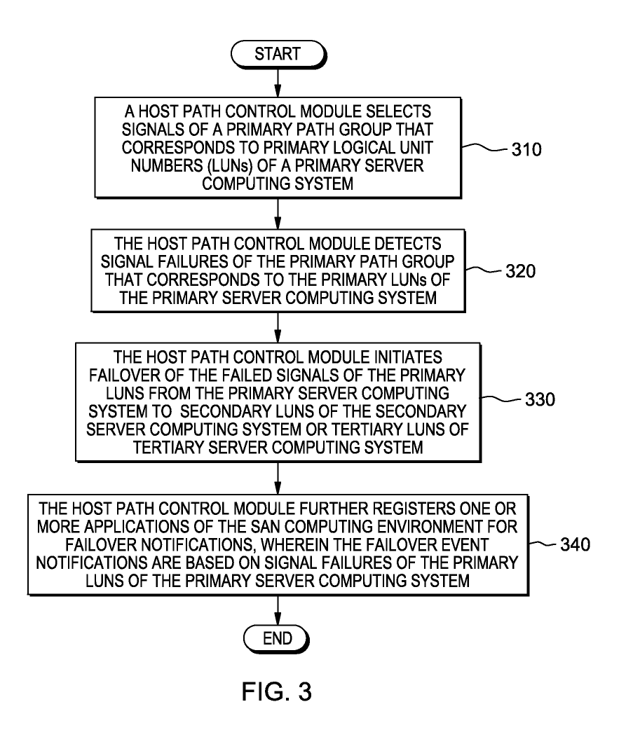

FIG. 3 is a flow diagram depicting steps performed by host path control module 130 for providing SCSI inband protocol for managing replication services of SAN computing environment 100 by transmitting SCSI commands to primary server computing system 110, secondary server computing system 115 and tertiary server computing system 120 within SAN computing environment 100. Host path control module 130 selects signals of a primary path group that corresponds to primary LUNs of primary server computing system 110 (Step 310).

If a failed outage is detected at primary server computing system 110, at least one or more of the primary path groups of primary server computing system 110 are identified as failed. Further, the signals of the primary path groups are input and output signals of the SAN computing environment 100. For instance, in a peer to peer remote copy (PPRC) environment of SAN computing environment 100, (I/O) operations are allowed only on primary LUNs of SAN computing environment 100. Further, the I/O operations are not allowed on the secondary LUNs or tertiary LUNs of tertiary server computing system 120.

Therefore, host path control module 130 typically issues I/O signal operations to the primary path group that corresponds to the primary LUNS. The primary paths group corresponds to the primary LUNs replication devices, including, for example, primary server computing system 110 of SAN computing environment 100. Host path control module 130 detects signal failures of the primary path group that corresponds to the primary LUNs of primary server computing system 110 (Step 320). For example, in the event of an outage or disaster at the primary site of primary computing system, host path control module 130 detects I/O failures of primary LUNs of primary server computing system 110. Further, after the failed signals are detected, a failover from primary LUNs to secondary LUNs or tertiary LUNs is initiated within SAN computing environment 100. Host path control module 130 initiates failover of the failed signals of primary LUNs from primary server computing system 110 to secondary LUNS of secondary server computing system 115 or tertiary LUNs of tertiary server computing system 120 (Step 330). Also, in at least one embodiment, there are also two possibilities for initiating the failover: first, host path control module 130 can initiate the failover, or second, alternatively at least one application of SAN computing environment 100 can initiate the failover.

According to at least one embodiment, host path control module 130 transmits small computer interface commands (SCIC) to initiate the failover from primary server computing system 110 to secondary server computing system 115 or tertiary server computing system 120. If transmission of the SCIC to secondary server computing system 115 is successful, host path control module 130 designates at least one secondary path group or at least one tertiary path group of the SAN computing environment as a primary path group. In at least one embodiment, host path control module 130 can also designate primary LUNs of primary server computing system 110 as a preferred LUNs, wherein the primary LUNs is designated as the preferred LUNs when the failover of the failed signals of the primary LUNs from the primary device to secondary LUNs of to secondary server computing system 115 or tertiary server computing system 120 is complete. In this manner, host path control module 130 can detect the preferred LUNs of primary server computing system 110 to access primary server computing system 110 once primary server computing system 110 becomes accessible, after the failover event in primary server computing system 110.

Host path control module 130 further registers one or more applications of SAN computing environment 100 for failover notifications, wherein the failover event notifications are based on signal failures of the primary LUNs of primary server computing system 110 (Step 340). In one embodiment, at least one or more applications operating on SAN computing environment 100 can register for a failover notification with host path control module 130.

For example, applications of SAN computing environment 100 registers with host path control module 130 for failover event notification in order to initiate failover of SAN computing environment 100. Host path control module 130 transmits the failover event to the registered applications in the event of I/O failures to primary storage device of primary server computing system.

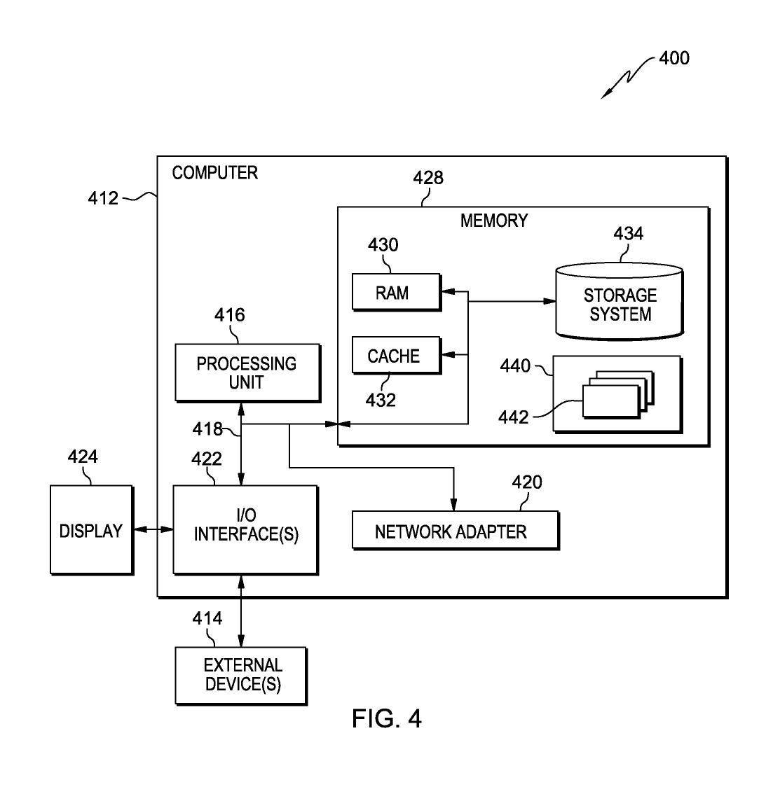

FIG. 4 is a block diagram of a computer system, in accordance with an embodiment of the present invention.

Computer system 400 is only one example of a suitable computer system and is not intended to suggest any limitation as to the scope of use or functionality of embodiments of the invention described herein. Regardless, computer system 400 is capable of being implemented and/or performing any of the functionality set forth hereinabove. In computer system 400 there is computer 412, which is operational with numerous other general purpose or special purpose computing system environments or configurations. Examples of well-known computing systems, environments, and/or configurations that may be suitable for use with computer 412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Host server computing system 105, primary server computing system 110, secondary server computing system 115 and tertiary server computing system 120 can be implemented as an instance of computer 412.

Computer 412 may be described in the general context of computer system executable instructions, such as program modules, being executed by a computer system. Generally, program modules may include routines, programs, objects, components, logic, data structures, and so on that perform particular tasks or implement particular abstract data types. Computer 412 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 4, computer 412 is shown in the form of a general-purpose computing device. The components of computer 412 may include, but are not limited to, one or more processors or processing units 416, memory 428, and bus 418 that couples various system components including memory 428 to processing unit 416.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 412 typically includes a variety of computer system readable media. Such media may be any available media that is accessible by computer 412 and includes both volatile and non-volatile media and removable and non-removable media.

Memory 428 includes computer system readable media in the form of volatile memory, such as random access memory (RAM) 430 and/or cache 432. Computer 412 may further include other removable/non-removable, volatile/non-volatile computer system storage media. By way of example only, storage system 434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 418 by one or more data media interfaces. As will be further depicted and described below, memory 428 may include at least one program product having a set (e.g., at least one) of program modules that are configured to carry out the functions of embodiments of the invention.

Host path control module 130 can be stored in memory 428 by way of example, and not limitation, as well as an operating system, one or more application programs, other program modules, and program data. Each of the operating system, one or more application programs, other program modules, and program data or some combination thereof, may include an implementation of a networking environment. Program modules 442 generally carry out the functions and/or methodologies of embodiments of the invention as described herein. Host path control module 130 can be implemented as an instance of program 440.

Computer 412 may also communicate with one or more external device(s) 414, such as a keyboard, a pointing device, etc., as well as display 424; one or more devices that enable a user to interact with computer 412; and/or any devices (e.g., network card, modem, etc.) that enable computer 412 to communicate with one or more other computing devices. Such communication occurs via Input/Output (I/O) interface(s) 422. Still yet, computer 412 communicates with one or more networks such as a local area network (LAN), a general wide area network (WAN), and/or a public network (e.g., the Internet) via network adapter 420. As depicted, network adapter 420 communicates with the other components of computer 412 via bus 418. It should be understood that although not shown, other hardware and/or software components could be used in conjunction with computer 412. Examples include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations are implemented by special purpose hardware-based systems that perform the specified functions or acts, or combinations of special purpose hardware and computer instructions.

As will be appreciated by one skilled in the art, embodiments of the present invention may be embodied as a system, method, or computer program product. Accordingly, embodiments of the present invention may take the form of an entirely hardware embodiment, an entirely software embodiment (including firmware, resident software, micro-code, etc.), or an embodiment combining software and hardware aspects that may all generally be referred to herein as a “circuit”, “module” or “system”. Furthermore, embodiments of the present invention may take the form of a computer program product embodied in one or more computer-readable medium(s) having computer-readable program code embodied thereon.

In addition, any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that contains or stores a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagates, or transports a program for use by or in connection with an instruction execution system, apparatus, or device.

Program code embodied on a computer-readable medium may be transmitted using any appropriate medium, including, but not limited to, wireless, wireline, optical fiber cable, RF, etc., or any suitable combination of the foregoing. Computer program code for carrying out operations for embodiments of the present invention may be written in any combination of one or more programming languages, including an object-oriented programming language such as Java, Smalltalk, C++ or the like, conventional procedural programming languages such as the “C” programming language, a hardware description language such as Verilog, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Based on the foregoing a method for providing small computer system interface inband protocol for managing replication services of a storage area network computing environment by transmitting small computer system interface commands to computing systems of the storage area network computing environment have been disclosed. However, numerous modifications and substitutions can be made without deviating from the scope of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. Therefore, the present invention has been disclosed by way of example and not limitation.

What is claimed is:

1. A computer system for providing small computer system interface inband protocol for managing replication services of a storage area network computing environment by transmitting small computer system interface commands to computing systems of the storage area network computing environment, the computer system comprising:
one or more processors, one or more computer-readable memories, one or more computer-readable tangible storage devices, and program instructions which are stored on at least one of the one or more storage devices for execution by at least one of the one or more processors via at least one of the one or more memories, the program instructions comprising:
program instructions to select signals of a primary path group that corresponds to a primary logical unit number of a primary device of a storage area network computing environment;
program instructions to detect signal failures of the primary path group that corresponds to the primary logical unit number;
program instructions to initiate failover of the failed signals of the primary logical unit number from the primary device to a secondary logical unit number of a secondary device or a tertiary logical unit number of a tertiary device; and
program instructions to register one or more applications of the storage area network computing environment for failover event notifications, wherein the failover event notifications are based on signal failures of the primary logical unit number of the primary device.

2. The computer system according to claim 1 further includes:
program instructions to designate the primary logical unit number of the primary device as a preferred logical unit number, wherein the primary logical unit number is designated as the preferred logical unit number when the failover of the failed signals of the primary logical unit number from the primary device to the secondary logical unit number of the secondary device or the tertiary logical unit number of the tertiary device is complete; and
program instructions to detect the preferred logical unit number of the primary device to access the primary device once it becomes accessible.

3. The computer system according to claim 1, wherein program instructions to initiate failover of the failed signals of the primary logical unit number from the primary device to a secondary logical unit number of a secondary device or a tertiary logical unit number of a tertiary device, further includes: program instructions to select one or more options to initiate the failover of the failed signals of the primary logical unit number from the primary device to the secondary device or the tertiary device, wherein the selection is based on user defined configurations in a user interface of the storage area network computing environment.

4. The computer system according to claim 3, wherein at least one or more path groups that correspond to the primary logical unit number are primary path groups of a replication device of the storage area network computing environment.

5. The computer system according to claim 4 further includes:
program instructions to transmit small computer system interface commands to a secondary device or a tertiary device to initiate failover from the primary logical unit number of the primary device to a secondary logical unit number of the secondary device or a tertiary logical unit number of the tertiary device.

6. The computer system according to claim 5 further includes: program instructions to designate at least one secondary path group or at least one tertiary path group of the storage area network computing environment as a primary path group if transmission of the small computer system interface commands to the secondary device is successful.

7. A computer program product for providing small computer system interface inband protocol for managing replication services of a storage area network computing environment by transmitting small computer system interface commands to computing systems of the storage area network computing environment, the computer program product comprising:
one or more computer-readable tangible storage devices and program instructions stored on at least one of the one or more storage devices, the program instructions comprising:
program instructions to select signals of a primary path group that corresponds to a primary logical unit number of a primary device of a storage area network computing environment;
program instructions to detect signal failures of the primary path group that corresponds to the primary logical unit number;
program instructions to initiate failover of the failed signals of the primary logical unit number from the primary device to a secondary logical unit number of a secondary device or a tertiary logical unit number of a tertiary device; and
program instructions to register one or more applications of the storage area network computing environment for failover event notifications, wherein the failover event notifications are based on signal failures of the primary logical unit number of the primary device.

8. The computer program product according to claim 14 further includes:
program instructions to designate the primary logical unit number of the primary device as a preferred logical unit number, wherein the primary logical unit number is designated as the preferred logical unit number when the failover of the failed signals of the primary logical unit number from the primary device to the secondary logical unit number of the secondary device or the tertiary logical unit number of the tertiary device is complete; and
program instructions to detect the preferred logical unit number of the primary device to access the primary device once it becomes accessible.

9. The computer program product according to claim 8, wherein the program instructions to initiate failover of the failed signals of the primary logical unit number from the primary device to a secondary logical unit number of a secondary device or a tertiary logical unit number of a tertiary device, further includes: program instructions to select one or more options to initiate the failover of the failed signals of the primary logical unit number from the primary device to the secondary device or the tertiary device, wherein the selection is based on user defined configurations in a user interface of the storage area network computing environment.

10. The computer program product according to claim 9, wherein at least one or more path groups that correspond to the primary logical unit number are primary path groups of a replication device of the storage area network computing environment.

10. The computer program product according to claim 9 further includes:
program instructions to transmit small computer system interface commands to a secondary device or a tertiary device to initiate failover from the primary logical unit number of the primary device to a secondary logical unit number of the secondary device or a tertiary logical unit number of the tertiary device.

11. The computer program product according to claim 10 further includes: program instructions to designate at least one secondary path group or at least one tertiary path group of the storage area network computing environment as a primary path group if transmission of the small computer system interface commands to the secondary device is successful.

12. The computer program product according to claim 11, wherein if a failed outage is detected at the primary device, at least one or more of the primary path groups are identified as failed.
